(19) United States
(12) Patent Application Publication
(10) Pub. No.: US 2023/0136480 A1
(43) Pub. Date: May 4, 2023

(54) THERAPEUTIC VIBRATION MACHINE

(71) Applicant: David Anzelmo, Angola, IN (US)

(72) Inventor: David Anzelmo, Angola, IN (US)

(21) Appl. No.: 17/938,198

(22) Filed: Oct. 5, 2022

Related U.S. Application Data
(60) Provisional application No. 63/203,947, filed on Aug. 5, 2021.

(51) Int. Cl. A61H 1/00

(52) U.S. Cl. CPC A61H 1/005; A61H 2201/0119; A61H 2201/0192; A61H 2201/1685; A61H 2201/0161; A61H 2201/0157; A61H 23/02

(57) ABSTRACT

A therapeutic vibration machine with a vibrational assembly adjustably affixed to a post extending from a platform wherein the vibrational assembly is adjustable by an adjustment lever, a rest plate, a pressure plate, and pressure springs, the vibrational assembly includes a vibrational motor, an isolation mounting, and a surface plate wherein the isolation mounting is operative to transferring a vibration supplied from the vibrational motor to the surface plate for utilization by a user.

### CROSS-REFERENCE TO RELATED APPLICATION

This application claims the benefit of priority of U.S. provisional application No. 63/203,947, filed Aug. 5, 2021, the contents of which are herein incorporated by reference.

### BACKGROUND OF THE INVENTION

The present invention relates to therapeutic vibrations and, more particularly, to a machine therefor.

Individuals of all ages, from professional athletes to sedentary individuals need muscle flexibility and joint mobility for peak performance and optimal function. There are many solutions on the market claiming to ease, relieve or subside muscle pain through impacts or vibrations. Those solutions do not provide the necessary force and/or energy over a large enough vibrating surface area to effectively resolve muscle pain and tightness. They are not intuitive, lack efficiency and ease of use, and require instruction which often leads to misuse when unsupervised. Current machines lack a platform and require external force (other than the user's body weight) to be applied. They often require the assistance of another individual for the application to be effective.

The rising cost of health care has forced individuals to manage their symptoms and reduced function without relying on medications and procedures with uncertain outcomes.

As can be seen, there is a need for a therapeutic vibration machine with a high amplitude energy vibration, a large vibrating surface area commensurate to the application areas, a stable platform, and is self-directed and intuitive to use while only requiring the user's body weight on the machine.

### SUMMARY OF THE INVENTION

In one aspect of the present invention, a therapeutic vibration machine comprising a vibrational assembly adjustably affixed to a post extending from a platform wherein the vibrational assembly is adjustable by an adjustment lever, a rest plate, a pressure plate, and pressure springs wherein pressure plate by the pressure springs apply pressure to the post and the height adjustment lever adjusts the pressure to lock the vibrational assembly onto the post, the vibrational assembly comprises a vibrational motor, an isolation mounting, and a surface plate wherein the isolation mounting is operative to transferring a vibration supplied from the vibrational motor to the surface plate for utilization by a user, and a power source supplying power to the vibrating motor through a control box with an on/off switch and a speed dial.

Advantageously, the present invention may resolve soft tissue restrictions, enhance circulation, and improve function of various body parts or muscle groups through vibrational therapy.

The present invention was created to address common musculoskeletal issues. The present invention provides the mechanism and a road map to achieve relief and therapy in a cost effective and efficient manner.

The present invention may effectively resolve and maintain necessary muscle length and joint mobility in a time efficient self-directed manner. The present invention may be safe, easily adjustable, and provide a high energy therapeutic force as needed. A program of use of the present invention recognizes soft tissue and joint restrictions in key areas of the body as the primary generators of pain and dysfunction.

These and other features, aspects and advantages of the present invention will become better understood with reference to the following drawings, description, and claims.

### BRIEF DESCRIPTION OF THE DRAWINGS

FIG. 1A is a perspective view showing a first mode of use for a therapeutic vibration machine according to an embodiment of the present invention;

FIG. 1B is a perspective view showing a second mode of use thereof;

FIG. 2 is a perspective view of the therapeutic vibration machine thereof;

FIG. 3 is a side elevation view thereof;

FIG. 4 is a detail side elevation view thereof;

FIG. 5 is a cross-sectional view taken on line 5-5 of FIG. 4;

FIG. 6 is a block diagram detailing route for power to travel from a power source to a vibrating motor according to an embodiment of the present invention;

FIG. 7 is a detail side elevation view, similar to FIG. 4, showing an alternate configuration thereof;

FIG. 8 is a schematic view of a portable carrying case for the therapeutic vibration machine thereof;

FIG. 9 is a perspective view of a ball plate accessory according to an embodiment of the present invention;

FIG. 10 is a perspective view of a quad plate accessory according to an embodiment of the present invention;

FIG. 11 is a perspective view of a roller plate accessory according to an embodiment of the present invention;

FIG. 12 is a perspective view of a rocker accessory according to an embodiment of the present invention;

FIG. 13 is a cross-sectional view taken on line 13-13 of FIG. 12;

FIG. 14 is a bottom perspective view of the rocker accessory;

FIG. 15 is a perspective view of a portable stand according to an embodiment of the present invention;

FIG. 16 is an exploded view thereof; and

FIG. 17 is a side view detailing the pivot bracket thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a therapeutic vibrational machine to massage, relax, restore, heal, and relieve muscles with a powerful vibration and large vibrating surface area. The invention includes a vibrating mechanism. This mechanism concentrates different frequencies of movement into the muscles through a padded surface. The present invention may be used for recovery and training utilizing therapeutic energy in the form of eccentric vibration.

A platform steadies the machine against the frequencies of the vibration mechanism to prevent the invention from collapsing when powered on. The platform may be any size and manufactured of any material but is preferably a heavy and sturdy material to best steady the machine. The platform may be steadied by the user's body weight while the user is on the platform.

A sliding device may position the vibration mechanism along a post. The post may be substantially vertical. Ideally, the sliding device includes an attachment device, such as a bolt, on one end of the device which secures it in place along the post. In some embodiments, the attachment device is adjustable with a hand grip.

An electric motor is housed within the vibration mechanism and when powered on, causes the vibration mechanism to vibrate. In some embodiments, the electric motor may be adjusted to change a frequency of the vibration. The vibration mechanism may further comprise at least two plates, secured to different ends of the electric motor. A first plate may be a securement plate and attaches to the post or the sliding device. A second plate may be a vibration plate and be operative as a vibrating surface. At least one side of the vibration mechanism, such as the vibration plate, may be covered in a soft material or padding for the user's comfort.

A leveraging device may enable the user to leverage their weight to apply additional pressure against the vibration mechanism. The leveraging device may be a rope or a band or any device that the user determines provides adequate leverage when applying additional pressure against the vibration mechanism. The user may lean into the vibration plate in a vertical position while holding onto a leveraging device, such as a stretch band, to isolate a muscle, muscle group, or body part for vibrations.

In some embodiments, a single platform may support multiple posts and their accompanying vibration mechanisms attached to each respective post.

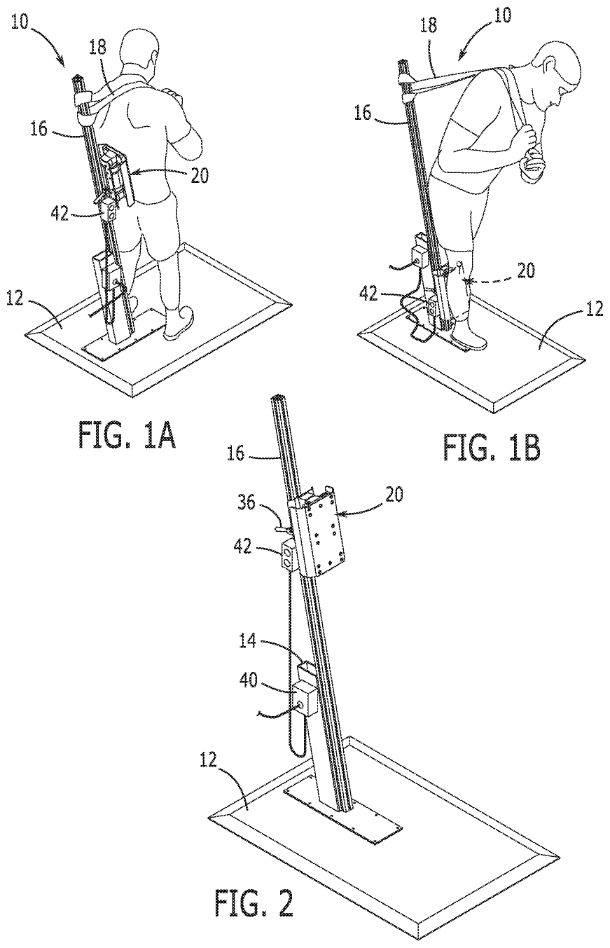

Referring now to the Figures, FIGS. 1-5 detail a therapeutic vibrational device 10 according to an embodiment of the present invention. FIG. 1A and FIG. 1B show a first mode of use and a second mode of use, respectively, for the therapeutic vibrational device 10. A vibrational assembly 20 may be positioned via a sliding mechanism and a height adjustment lever 36 on a post 16 stemming from a mounting mast 14 on a platform 12. A user may position themselves on the vibrational assembly 20, leveraging an elastic band 18 for a desirable position or mode of use.

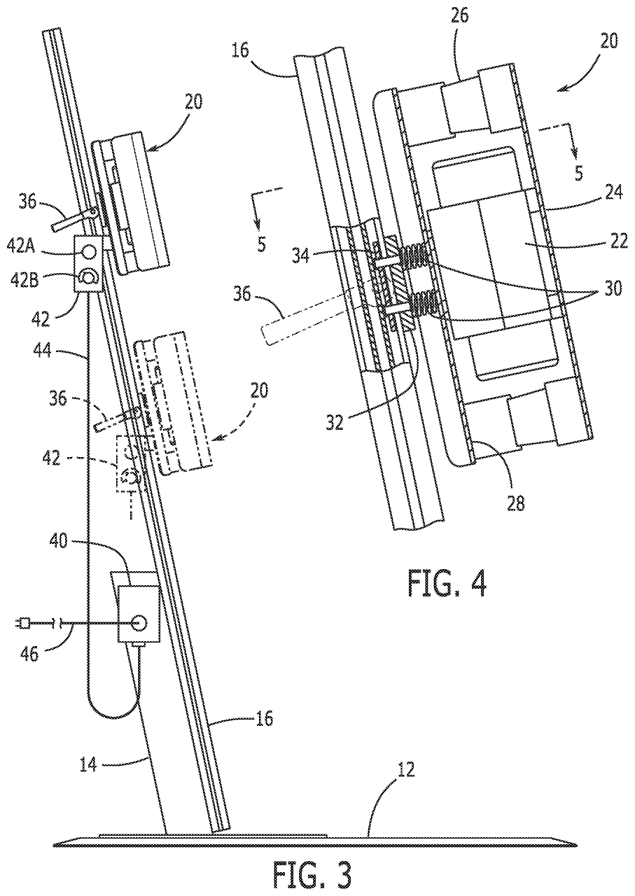

As shown in FIG. 3, the vibrational assembly 20 is affixed to a control box 42 electronically connected to a power relay box 40 by a connector cord 44. A power cord 46 extends from the power relay box 40. The control box 42 comprises an on/off switch 42A and a speed dial 42B. The vibrational assembly 20 is adjustably affixed to the post 16 and may be moved along the post 16.

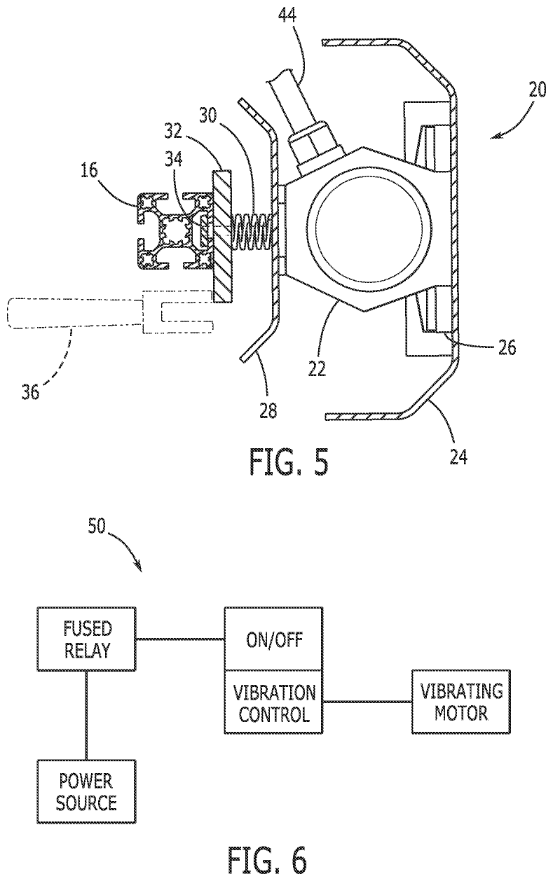

As shown in FIGS. 4 and 5, the vibrational assembly 20 comprises a vibrational motor 22, a surface plate 24, an isolation mounting 26, and a base plate 28. The isolation mounting transfers vibrations from the vibrational motor 22 to a surface plate 24 for utilization by the user. A rest plate 32 and a pressure plate 34 affix to the post 16 and may adjust the height of the vibrational assembly 20 along the post 16 by use of the height adjustment lever 36 and pressure springs 30. The pressure plate 34 by the pressure springs 30 apply pressure to the post 16, and the height adjustment lever 36 adjusts the pressure to lock the vibrational assembly 20 onto the post 16. The connector cord 44 attaches to the vibrational motor 22 to deliver power.

FIG. 6 details a block diagram of electrical components 50 of the present invention detailing origination at a power source and pathway to the vibrating motor.

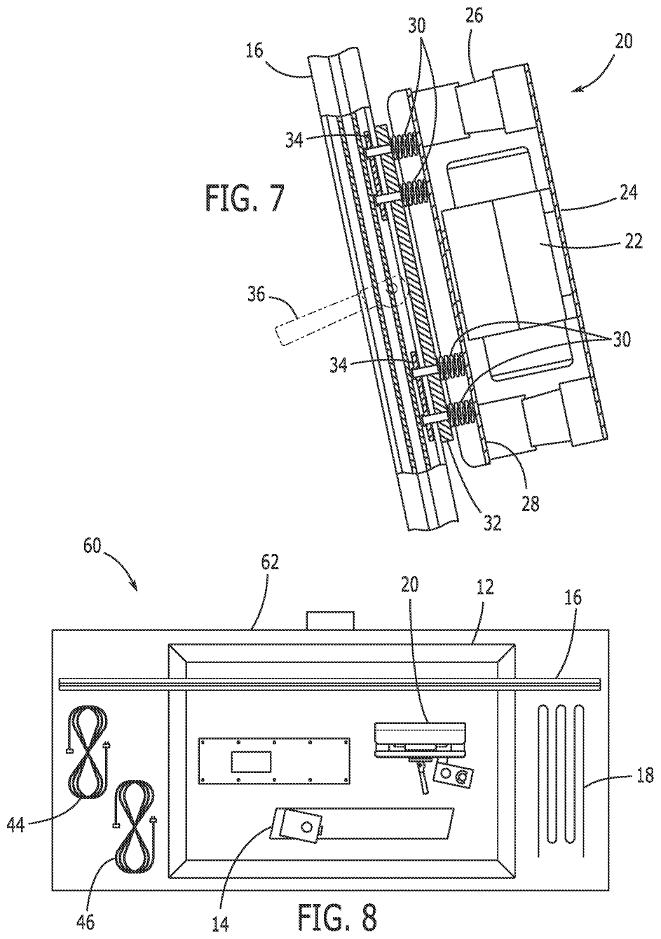

FIG. 7 is a detail view of the vibrational assembly according to another embodiment of the present invention. The embodiment features additional pressure springs 30 with the pressure plate 34 being larger and the rest plate 32 being larger as well.

FIG. 8 is a schematic view of a portable embodiment 60 of the present invention. A portable carrying case 62 may fit the post 16, elastic band 18, platform 12, vibrational assembly 20, mounting mast 14, connector cord 44, and power cord 46 as said components are dimensioned and configured to be assembled and joined together whenever desired and further unassembled and fit into the carrying case 62.

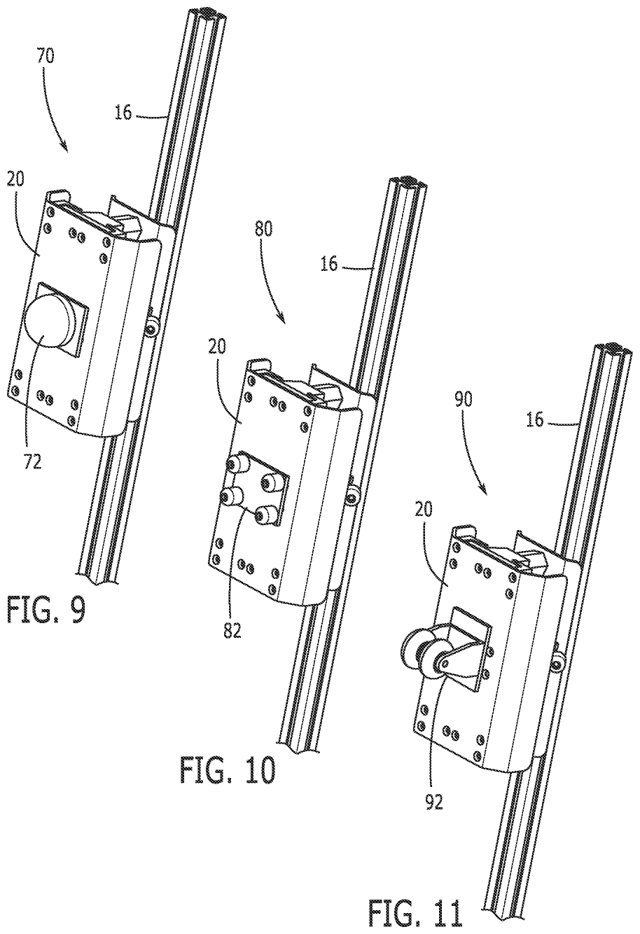

FIGS. 9-11 show perspective views of various attachments 72, 82, 92 removably attachable to the the vibrational assembly 20. FIG. 9 shows a ball accessory attachment 70 comprises a ball 72 which mounts on the vibrational assembly 20. FIG. 10 shows a quad accessory attachment 80 comprises a quad accessory 82 which mounts on the vibrational assembly 20. FIG. 11 shows a roller accessory attachment 90 comprises a roller 92 which mounts on the vibrational assembly 20.

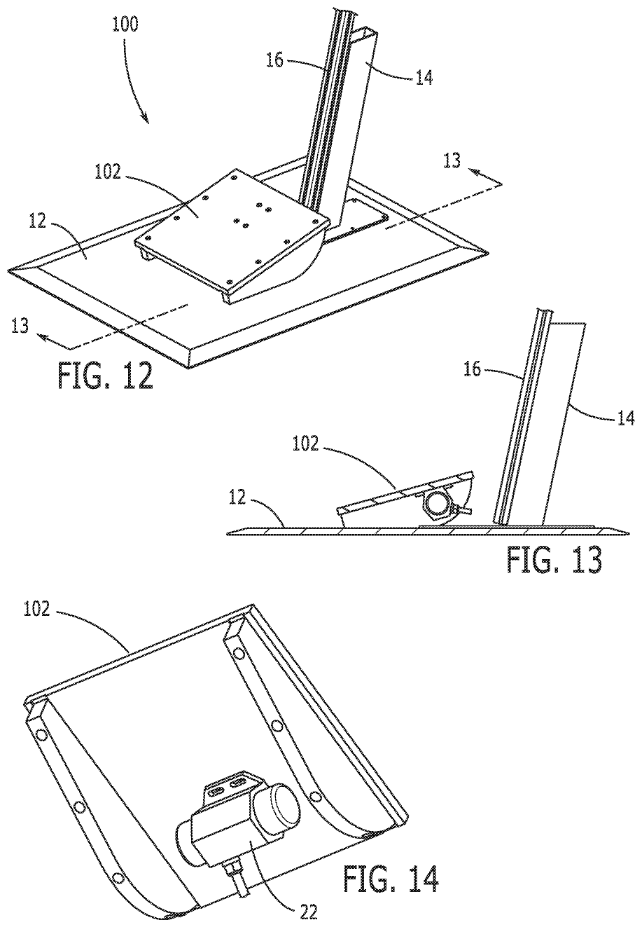

FIGS. 12-14 show a rocker accessory attachment 100 comprising a rocker 102 which mounts onto the platform 12 and a vibrational motor 22 which vibrates the rocker 102.

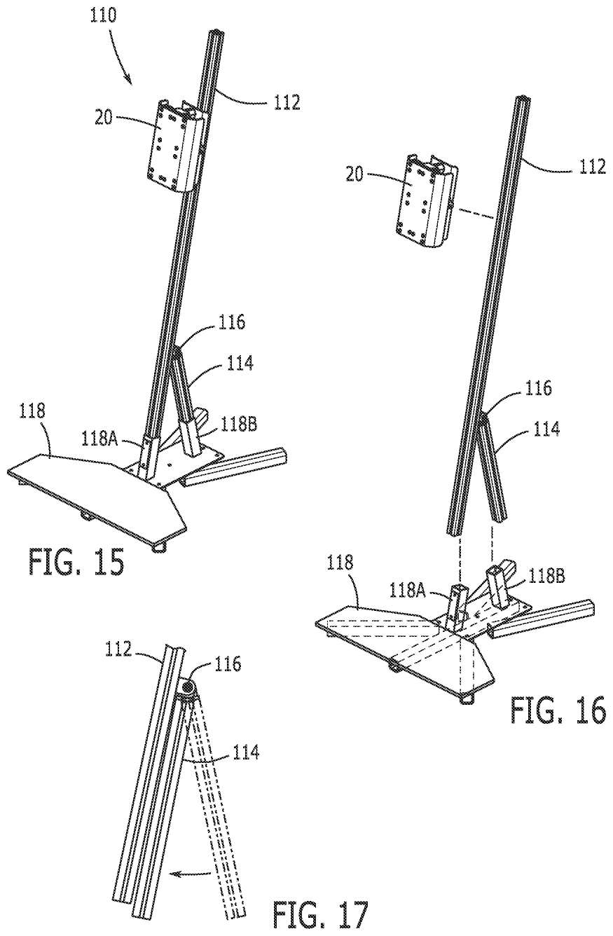

FIGS. 15-17 detail a portable embodiment 110 with a portable stand 118. The portable stand 118 comprises a post mount 18A and a support mount 18B to fit a portable post 112 and a support post 114 respectively. The portable post 112 and the support post 114 may be joined by a pivot bracket 116 best shown in FIG. 17. Such components are dimensioned and configured to be assembled and joined together whenever desired.

It should be understood, of course, that the foregoing relates to exemplary embodiments of the invention and that modifications may be made without departing from the spirit and scope of the invention as set forth in the following claims.

What is claimed is:

1. A therapeutic vibrational machine comprising:
a vibrational assembly adjustably affixed to a post extending from a platform wherein the vibrational assembly is adjustable by an adjustment lever, a rest plate, a pressure plate, and pressure springs wherein pressure plate by the pressure springs apply pressure to the post and the height adjustment lever adjusts the pressure to lock the vibrational assembly onto the post;
the vibrational assembly comprising a vibrational motor, an isolation mounting, and a surface plate wherein the isolation mounting is operative to transferring a vibration supplied from the vibrational motor to the surface plate for utilization by a user; and
a power source supplying power to the vibrating motor through a control box with an on/off switch and a speed dial.

2. The therapeutic vibrational machine of claim 1, further comprising an elastic band affixed to the post to leverage the user against the surface plate.

3. The therapeutic vibrational machine of claim 1, further comprising a ball plate accessory, removably attachable to the surface plate.

4. The therapeutic vibrational machine of claim 1, further comprising a quad plate accessory, removably attachable to the surface plate.

5. The therapeutic vibrational machine of claim 1, further comprising a roller plate accessory, removably attachable to the surface plate.

6. The therapeutic vibrational machine of claim 1, further comprising a carrying case wherein the therapeutic vibrational machine is dimensioned and configured to be unassembled and to fit into the carrying case.

7. The therapeutic vibrational machine of claim 1, further comprising a rocker accessory, mountable to the platform, wherein the rocker accessory comprises a vibrational motor.

8. The therapeutic vibrational machine of claim 1, wherein the platform is dimensioned and configured to be assembled and joined together with the post and further comprises support post and a pivot bracket joining the post to the support post.
